(19) United States
(12) Patent Application Publication
(10) Pub. No.: US 2019/0287384 A1
(43) Pub. Date: Sep. 19, 2019

(54) ACTIVE SHOOTER MITIGATION

(71) Applicant: L & J Consulting, LLC, Round Rock, TX (US)

(72) Inventor: James Stark Chapman, Round Rock, TX (US)

(73) Assignee: L & J Consulting, LLC, Round Rock, TX (US)

(21) Appl. No.: 16/352,788

(22) Filed: Mar. 13, 2019

Related U.S. Application Data
(60) Provisional application No. 62/761,192, filed on Mar. 13, 2018.

(51) Int. Cl. G08B 25/12; G08B 25/00; G08B 3/10; H04R 27/00

(52) U.S. Cl. CPC G08B 25/12; G08B 25/009; G08B 25/008; H04R 27/00; G08B 3/10

(57) ABSTRACT

An active shooter mitigation system includes a controller/receiver unit including a multi-channel relay control including a receiver and a plurality of relays, an alarm trigger module coupled to the multi-channel relay control including a memory device and an audio out circuit and a power failure circuit coupled to the multi-channel relay control and to the alarm trigger module including a back-up battery; and a plurality of remote transmitters.

### CROSS-REFERENCE TO RELATED APPLICATION

Referring to the application data sheet filed herewith, this application claims a benefit of priority under 35 U.S.C. 119(e) from copending provisional patent application U.S. Ser. No. 62/761,192, filed Mar. 13, 2018, the entire contents of which are hereby expressly incorporated herein by reference for all purposes.

### BACKGROUND

Prior art security systems are known to those skilled in the art. For instance, a conventional security system is typically equipped with a sound producing alarm. Often, a conventional security system will be equipped with a light producing alarm.

A problem with this technology has been that an intruder may continue their endeavor in spite of the alarm reasoning that there will be ample time to accomplish the purpose of their intrusion before a first responder arrives. Therefore, what is required is a solution that creates confusion or doubt in the mind of an intruder as to the arrival of a first responder. What is also needed is a solution that distracts the intruder from the original purpose of their intrusion.

Heretofore, the requirements of creating confusion or doubt in the mind of an intruder as to the arrival of a first responder and distracting the intruder from the original purpose of their intrusion referred to above have not been met. In view of the foregoing, there is a need in the art for a solution that simultaneously solves both of these problems.

### SUMMARY

There is a need for the following embodiments of the present disclosure. Of course, the present disclosure is not limited to these embodiments.

According to an embodiment of the present disclosure, an active shooter mitigation apparatus includes a controller/receiver unit including a multi-channel relay control including a receiver and a plurality of relays, an alarm trigger module coupled to the multi-channel relay control including a memory device and an audio out circuit and a power failure circuit coupled to the multi-channel relay control and to the alarm trigger module including a back-up battery; and a plurality of remote transmitters.

According to another embodiment of the present disclosure, an active shooter mitigation method includes powering up a controller/receiver unit including a multi-channel relay control including a receiver and a plurality of relays, an alarm trigger module coupled to the multi-channel relay control including a memory device and an audio out circuit and a power failure circuit coupled to the multi-channel relay control and to the alarm trigger module including a back-up battery and a plurality of remote transmitters; and setting the control/receiver unit to an armed ready state.

These, and other, embodiments of the present disclosure will be better appreciated and understood when considered in conjunction with the following description and the accompanying drawings. It should be understood, however, that the following description, while indicating various embodiments of the present disclosure and numerous specific details thereof, is given for the purpose of illustration and does not imply limitation. Many substitutions, modifications, additions and/or rearrangements may be made within the scope of embodiments of the present disclosure, and embodiments of the present disclosure include all such substitutions, modifications, additions and/or rearrangements.

### BRIEF DESCRIPTION OF THE DRAWINGS

The drawings accompanying and forming part of this specification are included to depict certain embodiments of the present disclosure. A clearer concept of the embodiments described in this application will be readily apparent by referring to the exemplary, and therefore nonlimiting, embodiments illustrated in the drawings (wherein identical reference numerals (if they occur in more than one view) designate the same elements). The described embodiments may be better understood by reference to one or more of these drawings in combination with the following description.

The described embodiments may be better understood by reference to one or more of these drawings in combination with the following description presented herein. It should be noted that the features illustrated in the drawings are not necessarily drawn to scale.

FIG. 1 is a block schematic diagram view of an active shooter mitigation apparatus.

### DETAILED DESCRIPTION

Embodiments presented in the present disclosure and the various features and advantageous details thereof are explained more fully with reference to the nonlimiting embodiments that are illustrated in the accompanying drawings and detailed in the following description. Descriptions of well known materials, techniques, components and equipment are omitted so as not to unnecessarily obscure the embodiments of the present disclosure in detail. It should be understood, however, that the detailed description and the specific examples are given by way of illustration only and not by way of limitation. Various substitutions, modifications, additions and/or rearrangements within the scope of the underlying inventive concept will become apparent to those skilled in the art from this disclosure.

Ultra is a non-lethal methodology used to reduce casualties in an active shooter scenario. Its methodology replicates the presence of law enforcement first responders through the use of auditory and optical mimicry in order to distract and confuse a shooter. The perception that first responders are present may persuade a shooter to hide or flee prematurely rather than pursue more casualties. Any reduction of shooting caused by the confusion will help mitigate the amount of injury or death. Ultra can be configured to preexisting sound systems or installed as a stand alone apparatus, and can be activated remotely or by hardwired activation. Ultra's use of audio amplification may also be used to help direct and clear areas for law enforcement arriving at the scene.

Ultra-playback library is customized and may include, but not limited to:
1) Police sirens
2) Police radio calls
3) Recordings of gunfire or explosions
4) Commands and orders from police
5) Flashing lights and optical distractions

This active shooter mitigation apparatus and method creates confusion or doubt in the mind of an intruder as to the arrival of a first responder. The active shooter mitigation apparatus and method distracts the intruder from the original purpose of their intrusion. In a preferred embodiment, the active shooter mitigation apparatus and methodology causes the intruder to give up their original purpose and flee before a first responder arrives.

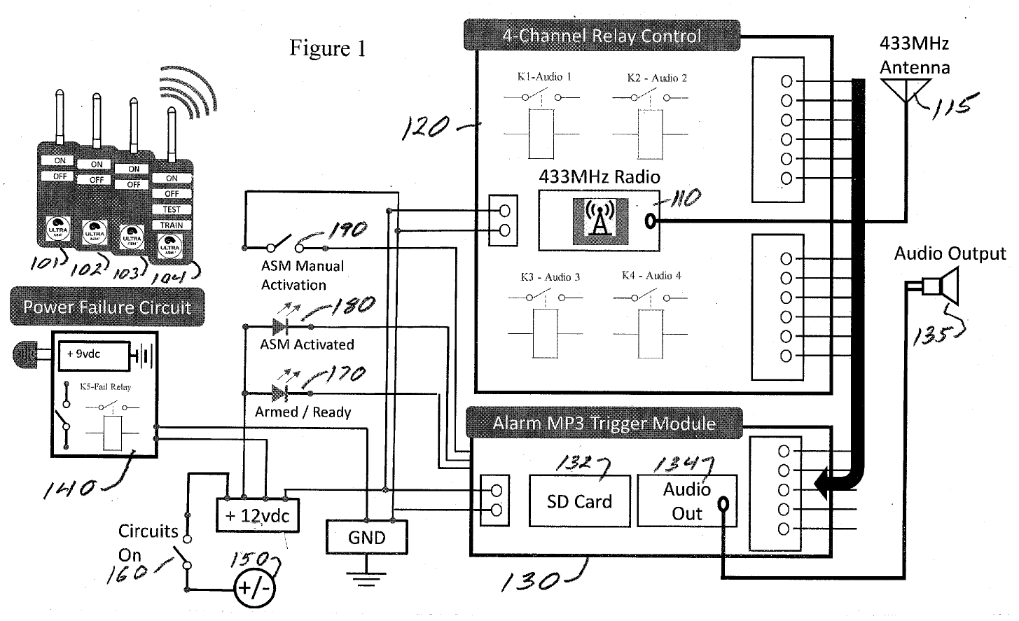

FIG. 1 illustrates a preferred embodiment of an active shooter mitigation apparatus. Four remote transmitters 101, 102, 103, 104 are radio frequency coupled to a receiver 110 via an antenna 115. Of course, the invention is not limited to four remote transmitters and there can be more or less remote transmitters. In this embodiment three of the remote transmitters 101, 102, 103 have an on function and an off function. One of the remote transmitters 104 (this remote can be termed a main remote and is intended for use by an administrator) also has a test function and a train function in addition to the on function and the off function. Of course, the invention is not limited to 433 MHz and the remotes and radio can be based on other frequency bands, be in-turn coupled to other links such as LAN, WAN, internet and there can be addition, even multiple, communication links as long as the remotes provide the above described functions. Also, there may be more than four remotes and the remotes may be provided with additional, other functions.

Referring to FIG. 1, a controller receiver unit includes the receiver 110 and the antenna 115. The receiver 110 and the antenna 115 are part of a 4-channel relay control 120. The 4-channel relay control includes 4 relays K1, K2, K3, K4 corresponding to the 4 remote transmitters. Of course, the invention is not limited to 4 channels and there can be more or less channels corresponding to the number of remote transmitters. An alarm MP3 trigger module 130 is coupled to the relay control 120. Of course, the invention is not limited to MP3 and the trigger module can use other file formats for audio and/or actinic signal data. The alarm MP3 trigger module includes an SD card 132. Of course, the invention is not limited to this chip standard or its form factor and the invention can use other memory devices as long as they provide a non-transitory computer readable media for the for audio and/or actinic signal data. An audio out 134 is coupled to the SD card. An audio output 135 is coupled to the audio out 134. The audio output 135 can be an existing public address system, one or more speakers or another type of audio output.

Still referring to FIG. 1, the controller receiver unit includes a power failure circuit 140. The power failure circuit 140 is coupled to both the 4-channel relay control 120 and the alarm MP3 trigger module 130. The power failure circuit 140 includes a backup battery and a device to indicate status of the power failure circuit. The power failure circuit 140 includes a relay K5.

Still referring to FIG. 1, the controller receiver unit includes a voltage source 150. A circuits on switch 160 is coupled to the voltage source. The controller receiver unit includes an armed/ready indicator 170. The controller receiver unit includes an active shooter mitigation activated indicator 180. The controller receiver unit includes an active shoot manual activation switch 190.

Operation of an active shooter mitigation apparatus will now be described. Operation of the active shooter mitigation apparatus can include the following operations in the following order.

Verify that the controller/receiver unit is mounted and installed correctly. It is important that the audio output of the controller/receiver unit is functionally connected to an audio input of the public address system control.

Provide each of the remote transmitters with a suitable battery to provide power for that remote transmitter. Turn on each remote transmitter by switching its on/off switch to the “ON” position.

Power to the controller/receiver can be provided by plugging an energized 120 vac/12 vdc adapter into the controller/receiver unit. Enable power to the controller/receiver unit by switching the Circuits On switch of the controller/receiver unit to the “ON” position.

Engage an armed/ready state of the controller/receiver unit by pressing the “OFF” button on one of the remote transmitters. In a preferred embodiment this results in a green LED on the controller/receiver unit representing the armed/ready state being illuminated.

Test the apparatus's operational function by pressing the “TEST” button on the main remote transmitter. In the preferred embodiment this results in a green LED representing the activated state being illuminated and a sound track (e.g. Star Spangled Banner) can be heard through the public address system speakers.

Again, engage the armed/ready state of the controller/receiver unit by pressing the “OFF” button on any of the remote transmitters. In the preferred embodiment this results in the green LED representing the armed/ready state being illuminated, the green LED representing the activated state stops being illuminated and the sound track stops playing.

Pressing one of the remote transmitters' “ON” button will activate an active shooter mitigation alarm. Then, pressing one of the remote transmitters' “OFF” button will turn the alarm “OFF” and return the active shooter mitigation apparatus to the armed/ready state. Opening the manual activation switch cover and turning the manual activation switch to the “ON” position will activate the active shooter mitigation apparatus alarm. Then, closing the manual activation switch cover and turning the manual activation switch to the “OFF” position will deactivate the active shooter mitigation alarm and return to the armed/ready state. In the preferred embodiment, the controller/receiver unit includes a manual activation switch cover that will mechanically interoperate to simultaneously turn the manual activation switch to the “OFF” position when the cover is closed.

Press the “OFF” button one one of the remote transmitters will arm and ready the active shooter mitigation apparatus. Since the active shooter mitigation apparatus is in an armed/ready state, pressing the “ON” button on one of the remote transmitters will activate the alarm of the active shooter mitigation apparatus.

Installation of an active shooter mitigation apparatus will now be described. Installation of the active shooter mitigation apparatus can include the following operations in the following order.

Verify that the existing public address system is functioning properly and completely. Since the location and path of an intruder cannot be predicted in advance, all of the speakers of the existing public address system should be functioning and connected to the signal input that will provide the auditory signal from the controller/receiver unit.

Identify the location of a) 110-120 Vac supply power, b) controller/receiver unit mounting and c) audio input to the public address system. The controller/receiver unit can be mounted on a wall at approximately chest height close to a public address system control panel.

Mount the controller/receiver to a solid fixture, such as a wall or cabinet so that the public address system is no more than 100 feet from the mounted controller/receiver unit. A patch cord of up to 100 feet can be used to coupled the controller/receiver unit to the public address system.

Connect the audio output cable from the controller/receiver unit to the designated public address system audio input. The audio input of the public address system must be a dedicated live feed so when the active shooter mitigation apparatus is activated, the audio is directly connected and delivered to all the public address system's speakers.

Using the attached power cord, plug the controller/receiver unit into the AC power outlet. Provide the power failure circuit of the controller/receiver with a suitable battery.

Prepare the active shooter mitigation system for testing by switching the circuits on switch to the “ON” position. Switch one of the transmitters' on/off switch to the “ON” position.

Using one of the transmitters, press the “OFF” button to arm and ready the active shooter mitigation apparatus. Test the proper functioning of the active shooter mitigation apparatus as described above.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences. The individual components of embodiments of the present disclosure need not be formed in the disclosed shapes, or combined in the disclosed configurations, but could be provided in any and all shapes, and/or combined in any and all configurations.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” or “mechanism for” or “step for”. Sub-generic embodiments of this disclosure are delineated by the appended independent claims and their equivalents. Specific embodiments of this disclosure are differentiated by the appended dependent claims and their equivalents.

What is claimed is:

1. An active shooter mitigation apparatus, comprising:
a controller/receiver unit including
a multi-channel relay control including a receiver and a plurality of relays,
an alarm trigger module coupled to the multi-channel relay control including a memory device and an audio out circuit and
a power failure circuit coupled to the multi-channel relay control and to the alarm trigger module including a back-up battery; and
a plurality of remote transmitters.

2. The apparatus of claim 1, further comprising a circuits on switch.

3. The apparatus of claim 2, further comprising a voltage source coupled to the circuits on switch.

4. The apparatus of claim 1, further comprising an armed/ready indicator coupled to the alarm trigger module.

5. The apparatus of claim 1, further comprising an active shooter mitigation activated indicator coupled to the alarm trigger module.

6. The apparatus of claim 1, further comprising an active shooter manual activation switch coupled to the alarm trigger module.

7. The apparatus of claim 1, wherein the receiver includes a 433 MHz receiver.

8. The apparatus of claim 1, wherein the memory device includes an SD card.

9. The apparatus of claim 1, wherein the power failure circuit includes a relay.

10. The apparatus of claim 1, wherein each of the plurality of remote transmitters includes a 433 MHz transmitter.

11. The apparatus of claim 1, further comprising a public address system.

12. A public address system, comprising the apparatus of claim 1.

13. An active shooter mitigation method, comprising:
powering up
a controller/receiver unit including
a multi-channel relay control including a receiver and a plurality of relays,
an alarm trigger module coupled to the multi-channel relay control including a memory device and an audio out circuit and
a power failure circuit coupled to the multi-channel relay control and to the alarm trigger module including a back-up battery and
a plurality of remote transmitters; and
setting the control/receiver unit to an armed ready state.

14. The method of claim 13, further comprising activating the control/receiver unit to send the contents of the memory device to the audio out circuit.

15. The method of claim 14, further comprising switching the control/receiver unit off.

16. The method of claim 14, further comprising resetting the control/receiver unit to the armed ready state.

17. A non-transitory computer readable media comprising executable programming instructions for performing the active shooter mitigation method of claim 13.
